(19) United States
(12) Patent Application Publication
(10) Pub. No.: US 2019/0313788 A1
(43) Pub. Date: Oct. 17, 2019

(54) MODULAR DESK TOP ORGANIZER

(71) Applicant: Ugmonk Inc., Downington, PA (US)

(72) Inventor: Jeffrey SHELDON, Downington, PA (US)

(21) Appl. No.: 16/385,044

(22) Filed: Apr. 16, 2019

Related U.S. Application Data
(60) Provisional application No. 62/658,922, filed on Apr. 17, 2018.

(51) Int. Cl. A47B 47/00; F16B 1/00

(52) U.S. Cl. CPC A47B 47/0091; A47B 2200/0084; F16B 2001/0035; F16B 1/00

(57) ABSTRACT

A modular desk top organizer having a platform and an upper component. The platform include an upper surface and an oppositely facing lower surface. The upper surface has a plurality of grooves extending in a direction parallel to a longitudinal axis of the platform. The spacing between the grooves is consistent and equal. The upper component is positioned on the platform. The upper component has a plurality of legs which extends from a bottom surface of the upper component. The spacing of the legs is a multiple of the distance of the spacing of the grooves, allowing the upper component to be positioned in various positions and orientations on the platform.

### FIELD OF THE INVENTION

The present invention is directed to a modular desk top organizer. In particular, the invention is directed to a modular desk top organizer in which components can be arranged in a number of different configurations.

### BACKGROUND OF THE INVENTION

Desk top organizers are known which provide one or more compartments which can hold various kinds of desk top supplies. However, known desk organizers are often unsightly and liable to topple when filled with items. In addition, currently available desk or table top organizers, which often have a fixed arrangement of compartments in which to store items, are cumbersome and do not efficiently utilize space. The lack of modularity and the lack of ability to customize the desk top organizer to accommodate the needs of the user renders known desk top organizers ineffective or inefficient for many uses.

It would, therefore, be beneficial to provide a desk top organizer which is configured to efficiency and which can be personized. In particular, it would be beneficial to provide a desk top organizer which has modular components which can be added or removed from a base or platform, to allow the desk top organizer to be customized according to the needs of the current user.

### SUMMARY OF THE INVENTION

The invention relates to a method, system and apparatus to organize and personalize a tabletop workspace to achieve a universal mode for efficiency through modular component arrangements and accessories. The invention maybe used in all business, office or home environments.

The current invention relates to a customizable desk organizer designed to hold all of the essentials and eliminate the clutter. It acts as a central home base for the most used items so that they are always within reach. Most organizers are rigid and cannot adapt to the desired use, but the present invention is completely flexible and can be configured in hundreds of different ways.

An embodiment is directed to a desk or table top organizer having a platform and an upper component. The platform include an upper surface and an oppositely facing lower surface. The upper surface has a plurality of grooves extending in a direction parallel to a longitudinal axis of the platform. The spacing between the grooves is consistent and equal, with the spacing between adjacent grooves equal to a distance A. The upper component is positioned on the platform. The upper component has a plurality of legs which extends from a bottom surface of the upper component. A first pair of legs of the plurality of legs is spaced apart by a distance B. A second pair of legs of the plurality of legs is spaced apart by a distance C. The distance B is a multiple of the distance A and the distance C is a multiple of the distance A, allowing the upper component to be positioned in various positions and orientations on the platform.

An embodiment is directed to a desk or table top organizer having a platform, an upper component and a lower component. The platform has an upper surface and an oppositely facing lower surface. The upper surface has a plurality of grooves extending in a direction parallel to a longitudinal axis of the platform. The lower surface has a plurality of slots extending in a direction parallel to a longitudinal axis of the platform. The upper component is positioned on the platform. The upper component has a plurality of legs which extend from a bottom surface of the upper component. The plurality of legs are positioned in the grooves of the upper surface to maintain the upper component on the platform. The lower component is positioned on the platform. The lower component has a plurality of hanging clips positioned in the slots of the lower surface to maintain the lower component on the platform.

An embodiment is directed to a desk or table top organizer having a platform, and upper component and an extension component. The platform has an upper surface and an oppositely facing lower surface. The upper surface has a plurality of grooves extending in a direction parallel to a longitudinal axis of the platform. The lower surface has a plurality of slots extending in a direction parallel to a longitudinal axis of the platform. The upper component is positioned on the platform. The upper component has a plurality of legs which extend from a bottom surface of the upper component. The plurality of legs are positioned in the grooves of the upper surface to maintain the upper component on the platform. One or more platform magnets are positioned on one or more walls of the platform. The extension component has one or more component magnets positioned on one or more walls of the extension component. The one or more component magnets are configured to magnetically cooperate with the one or more platform magnets of the platform and have sufficient strength to releasably maintain the extension component in place relative to the platform, thereby preventing the unwanted movement of the extension component relative to the platform.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of a platform of an illustrative embodiment of the invention and illustrative components positioned thereon.

FIG. 2 is a perspective view of the platform of FIG. 1 with the illustrative components removed.

FIG. 3 is a cross-sectional view of the platform of FIG. 2 taken along line 3-3 of FIG. 2.

FIG. 4 is a cross-sectional view taken along line 4-4 of FIG. 1, showing mounting projections of respective illustrative components positioned in a respective groove of the platform.

FIG. 5 is a top perspective view of a first illustrative component for use with the platform.

FIG. 6 is a bottom perspective view of the illustrative component of FIG. 5.

FIG. 7 is a top perspective view of a second illustrative component for use with the platform.

FIG. 8 is a bottom perspective view of the illustrative component of FIG. 7.

FIG. 9 is a top perspective view of a third illustrative component for use with the platform.

FIG. 10 is a top perspective view of a fourth illustrative component for use with the platform.

FIG. 11 is a top perspective view of a platform of an alternate illustrative embodiment of the invention with evenly spaced parallel grooves or slots on an upper surface and mounting grooves or slots or slots on a lower surface of the platform and illustrative components which cooperate with the mounting grooves.

FIG. 12 is a bottom perspective view of the platform of FIG. 11.

FIG. 13 is a cross-sectional view of the platform of FIG. 11 taken along line 13-13 of FIG. 11, with the components removed.

FIG. 14 is a top perspective view of a first illustrative component for use with the platform of FIG. 11.

FIG. 15 is a perspective view of a hanging clip used to position and secure the components in the mounting grooves or slots or slots on the lower surface of the platform.

FIG. 16 is a perspective view of the hanging clip and the first illustrative component as insertion occurs onto the platform of FIG. 11.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

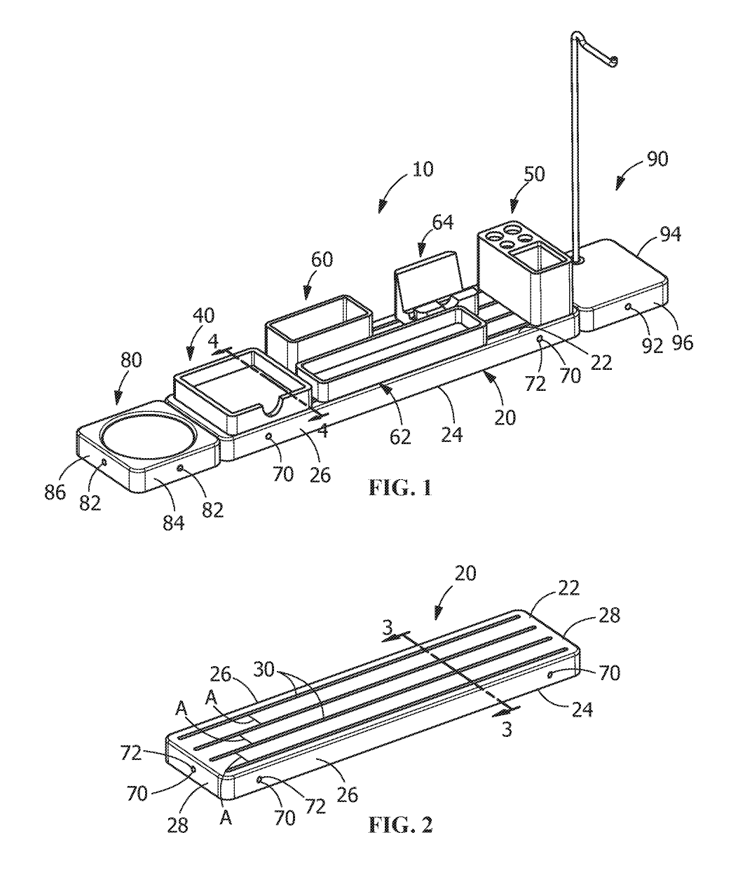

Referring to FIGS. 1 through 9, a first illustrative embodiment of a modular desk or table top organizer 10 is illustrated. The organizer 10 has a base or platform 20 on which various accessories or components 40 may be positioned, as is illustrated in FIG. 1.

As a best shown in FIGS. 2 through 4, the platform 20 has a top or upper surface 22 and an oppositely facing bottom or lower surface 24. Side walls 26 extend between the upper surface 22 and the lower surface 24. End walls 28 extend between the upper surface 20, the lower surface 24 and the sidewalls 26.

Grooves or slots 30 are provided in the platform 20 and extend from the upper surface 22 toward the lower surface 24. In the embodiment shown, the grooves or slots 30 extend from proximate one end wall 28 to approximate the other end wall 28. However, in other embodiments the grooves or slots 30 may extend through the end walls 28.

In the illustrative embodiment shown, four grooves or slots 30 extend across the width of the platform 20. However, other numbers of grooves or slots 30 may be used without departing from the scope of the invention. The spacing A between each pair of grooves or slots 30 is consistent and equal.

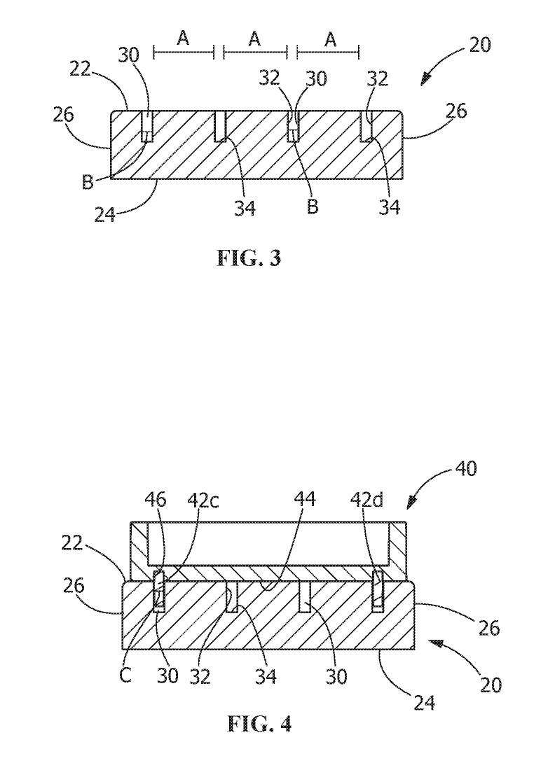

As best shown in FIG. 3, the grooves or slots 30 have side walls 32 and bottom walls 34. The side walls 32 of each respective grooves or slots 30 are spaced by a distance B. The side walls 32 are essentially parallel to each other and essentially perpendicular to the bottom or end wall 34. However, other configurations of the side walls 32 may be used. For example, the side walls 32 may be tapered so that the spacing between the side walls 32 proximate the upper surface 22 is greater than the spacing between the side walls 32 proximate the bottom or end wall 34.

The platform 20 may be made from, but are not limited to, solid wood, metal or plastic. The platform 20 may also have nonslip feet (not shown), such as, but not limited to, rubber feet, to prevent sliding of the platform 20 on a surface.

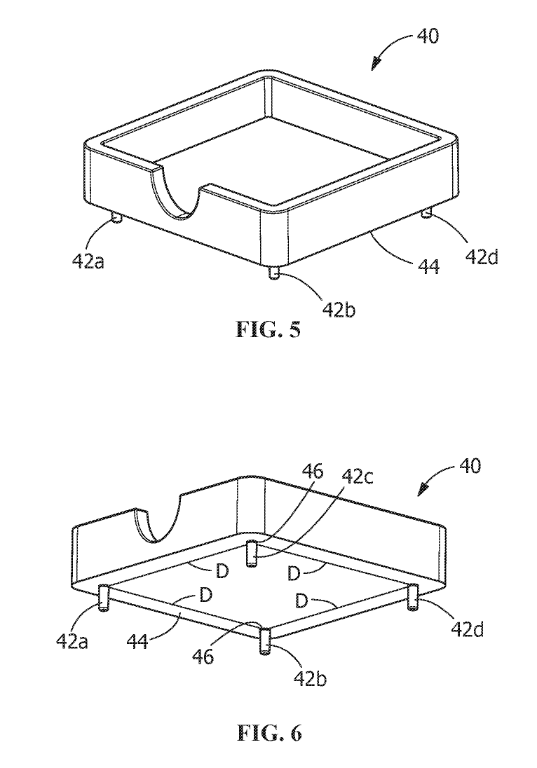

Referring to FIG. 5, a first illustrative component 40 is shown. The particular component 40 shown is configured to hold sticky notes. The component 40 can also be used to hold other small odds and ends such as paper clips, keys, loose change, etc.

As best shown in FIG. 6, the component 40 has pins or legs 42 which extend from a bottom surface 44 of the component 40. In the embodiment shown the pins or legs 42 extend from each respective corner of the bottom surface 44. However, in other embodiments, the pins or legs 42 may be positioned in other locations on the bottom surface 44.

As shown, the pins or legs 42 are separate pieces which are inserted into openings 46 in the bottom surface 44. The pins or legs 42 may be retained in the openings 46 by an interference fit, by an adhesive, or other known methods of retention. In alternate embodiments, the pins or legs 42 may be integrally molded with the bottom surface 44.

The pins or legs 42 have a generally cylindrical configuration with a relatively consistent diameter C. However, other configurations of the pins or legs 42 may be used. For example, the pins or legs 42 may be tapered so that the diameter of the pins or legs 42 is larger proximate the bottom surface 44 and smaller proximate free ends 48 of the pins or legs 42 which are spaced from the bottom surface.

Pins or legs 42a are spaced from pins or legs 42b by a distance D. For this component 40, the distance D is equal to three times the spacing A. Pins or legs 42c are spaced from pins or legs 42d by distance D. As the spacing A is consistent between grooves or slots 30, the spacing of the pins or legs 42a, 42b and 42c, 42d allows the components 40 to be positioned across four grooves or slots 30.

Pins or legs 42a are spaced from pins or legs 42c by a distance D. Pins or legs 42c are spaced from pins or legs 42d by distance D. As the spacing A is consistent between grooves or slots 30, the spacing of the pins or legs 42a, 42c and 42b, 42d allows the components 40 to be positioned across four grooves or slots 30.

As the component 40 has a square configuration, the component 40 can be rotated to fit on the platform 20 is different orientations. In addition, the component 40 can be moved and positioned anywhere in the direction of the the longitudinal axis of the platform 40.

When properly positioned, the pins or legs 42 of the component 40 are inserted into respective grooves or slots 30 of the platform, as shown in FIG. 4. In various embodiments, the diameter C of the pins or legs 42 is approximately equal to, but slightly larger, than the spacing B between the side walls 32 of the grooves or slots 30 of the platform 20. This allows the pins or legs 42 to have a frictional or interference fit with the grooves or slots 30, thereby maintaining the component 40 on the platform 20 and eliminating the unwanted movement of the component 40.

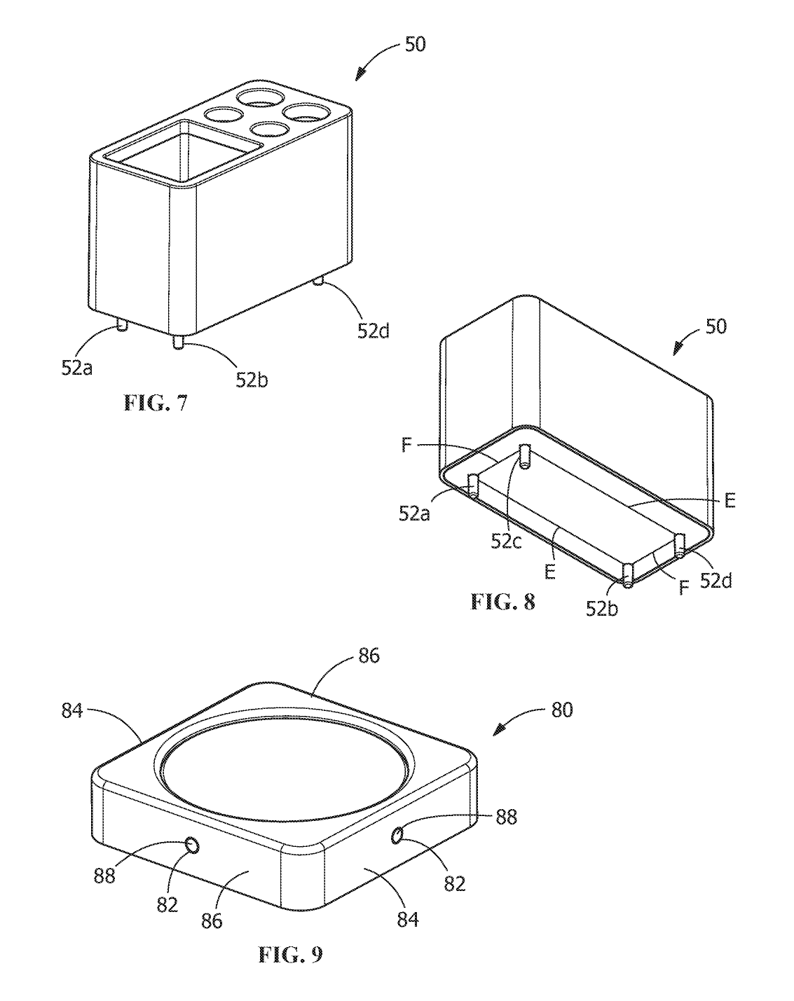

FIG. 7 illustrates an alternate illustrative component 50. Component 50 is a pen/pencil holder. The component 50 has a number of cavities to hold the pens/pencils. A large cavity is also provided to hold other odds and ends, such as paper clips, keys, loose change, etc.

Component 50 has pins or legs 52 which extend from a bottom surface 54. In the embodiment shown the pins or legs 52 extend from each respective corner of the bottom surface 54. However, in other embodiments, the pins or legs 52 may be positioned in other locations on the bottom surface 54.

As the pins or legs 52 are similar or identical to the pins or legs 42, the above description is incorporated and will not be repeated.

Pins or legs 52a are spaced from pins or legs 52b by a distance E. For this component 50, the distance E is equal to three times the spacing A. Pins or legs 52c are spaced from pins or legs 52d by distance E. As the spacing A is consistent between grooves or slots 30, the spacing of the pins or legs 52a, 52b and 52c, 52d allows the components 50 to be positioned across four grooves or slots 30.

Pins or legs 52a are spaced from pins or legs 52c by a distance F. Pins or legs 52c are spaced from pins or legs 52d by distance F. For this component 50, the distance F is equal to the spacing A. As the spacing A is consistent between grooves or slots 30, the spacing of the pins or legs 52a, 52c and 52b, 52d allows the components 50 to be positioned across two grooves or slots 30.

As the component 40 has a rectangular configuration, the component 50 can be rotated to fit on the platform 20 is different orientations. In addition, the component 50 can be moved and positioned anywhere in the direction of the longitudinal axis of the platform 50. As the pins or legs 52 have a frictional or interference fit with the grooves or slots 30, as described above, the component 50 is maintained on the platform 20, eliminating the unwanted movement of the component 50.

While components 40 and 50 are described above, the components can be any number of devices (as illustrated in FIG. 1), such as, but not limited to a small tray 60 (for holding paper clips, keys, loose change, etc.), a large tray 62 (for holding pens, markers, pocket knives, other elongated objects, etc.), or a phone stand 64 (for holding phones or tablets in an upright position). The pins or legs for each of the components are spaced from other respective pins or legs of the components by a distance which is equal to or a multiple of the spacing A. This allows the components to be rotated to fit on the platform 20 is different orientations.

The components may be made of materials which allow for the appropriate structural support, such as, but not limited to injection molded material. In various embodiments, the components may have a smooth surface and/or may be colored.

This allows the modular desk or table top organizer 10 to organize everything into one place. As various components can be positioned on the platform 20, the modular desk or table top organizer 10 can be configured according to the needs of the user,and reconfigured based on the changing needs of the user.

The platform 20 also includes platform magnets 70. The magnets 70 may be positioned on one or more side walls 26 and/or one or more end walls 28 of the platform 20. The positioning of the magnets 70 may vary, but in the embodiment shown, the magnets on the end walls 28 are positioned in the center thereof. The magnets 70 on the side walls 26 are spaced periodically along the length.

The magnets 70 may be used to removably attached two or more platforms 20 together to form a larger platform on which numerous and/or larger components can be positioned. The magnets 70 may also be used to attached additional components to the platform 20.

The magnets 70 are inset into the one or more side walls 26 and/or one or more end walls 28 of the platform 20, such that the outwardly facing magnetic surfaces 72 are essentially flush with the respective side walls 26 or end walls 28. The magnets 70 are configured to have sufficient strength to releasably maintain an extension component or additional platform 20 in place, thereby preventing the unwanted movement of the extension component or additional platform.

Referring to FIG. 9, a first illustrative extension component 80 is shown. The particular component 80 shown is a coaster.

The extension component 80 has component magnets 82 be positioned on one or more side walls 84 and/or one or more end walls 86 of the extension component 80. The positioning of the magnets 82 may vary, but in the embodiment shown, the magnets 82 are positioned in the center of the side walls 84 or end walls 86.

The magnets 82 are inset into the one or more side walls 84 and/or one or more end walls 86, such that the outwardly facing magnetic surfaces 88 are essentially flush with the respective side walls 84 or end walls 86. The magnets 82 are configured to magnetically cooperate with respective magnets 70 of the platform 20 and have sufficient strength to releasably maintain the extension component 80 in place relative to the platform 20, thereby preventing the unwanted movement of the extension component 80 relative to the platform 20.

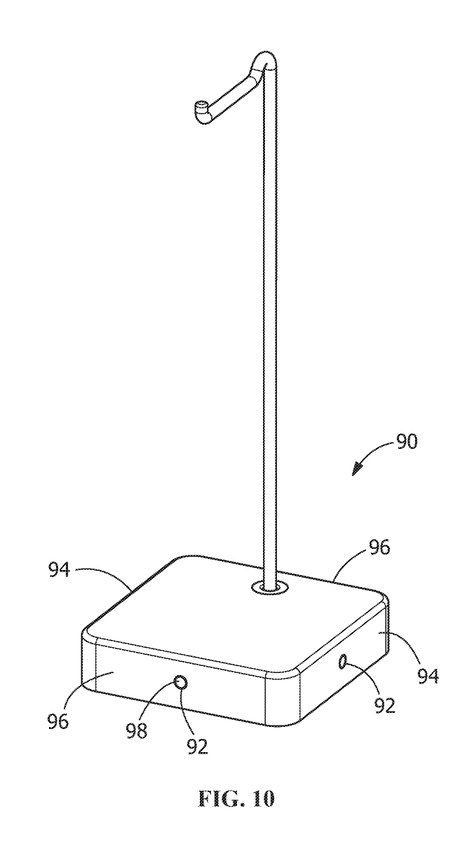

Referring to FIG. 10, a second illustrative extension component 90 is shown. The particular component 90 shown is a headphone stand to hold headphones when not in use.

The extension component 90 has magnets 92 be positioned on one or more side walls 94 and/or one or more end walls 96 of the extension component 90. The positioning of the magnets 92 may vary, but in the embodiment shown, the magnets 92 are positioned in the center of the side walls 94 or end walls 96.

The magnets 92 are inset into the one or more side walls 94 and/or one or more end walls 96, such that the outwardly facing magnetic surfaces 98 are essentially flush with the respective side walls 94 or end walls 96. The magnets 92 are configured to magnetically cooperate with respective magnets 70 of the platform 20 and have sufficient strength to releasably maintain the extension component 90 in place relative to the platform 20, thereby preventing the unwanted movement of the extension component 90 relative to the platform 20.

The extension components are not limited to the two extension components described above. Addition extension components may include power stations, reading lights, or any other component or device which is found at a work station.

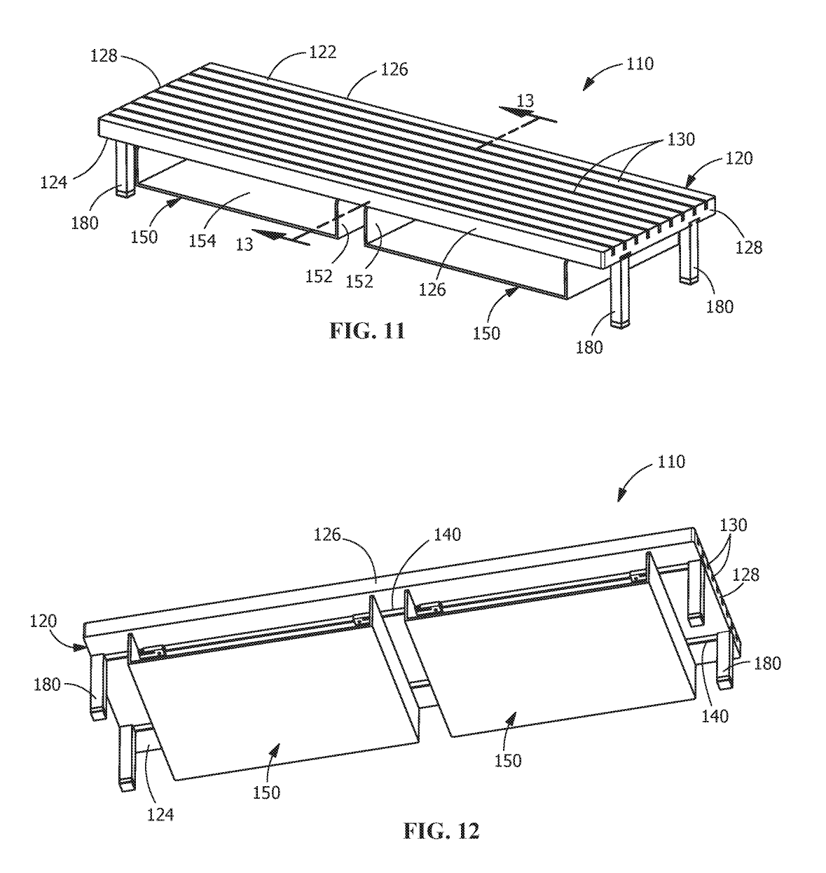

Referring to FIGS. 11 and 12, a second illustrative embodiment of a modular desk or table top organizer 110 is illustrated. The organizer 110 has a base or platform 120 on which various accessories or components may be positioned.

The platform 120 has a top or upper surface 122 and an oppositely facing bottom or lower surface 124. Side walls 126 extend between the upper surface 122 and the lower surface 124. End walls 128 extend between the upper surface 120, the lower surface 124 and the sidewalls 126. The platform 120 may be made from, but are not limited to, solid wood, metal or plastic.

Grooves or slots 130 are provided in the platform 120 and extend from the upper surface 122 toward the lower surface 124. In the embodiment shown, the grooves or slots 130 extend from one end wall 128 to the other end wall 128. However, in other embodiments the grooves or slots 130 may proximate to the end walls 128.

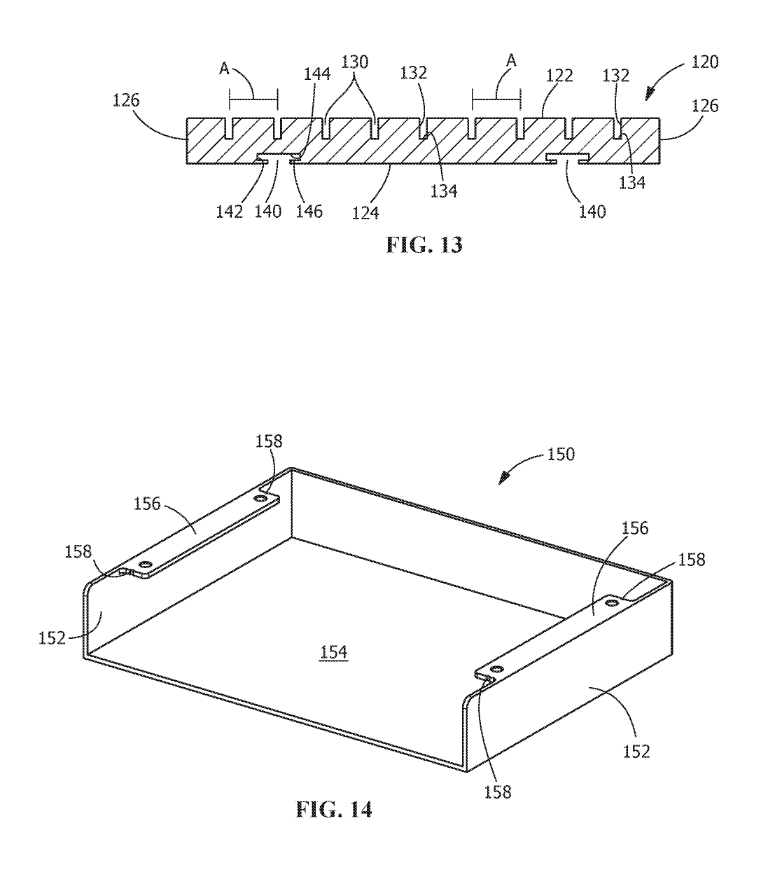

In the illustrative embodiment shown, nine grooves or slots 130 extend across the width of the platform 120. However, other numbers of grooves or slots 130 may be used without departing from the scope of the invention. The spacing A between each pair of grooves or slots 130 is consistent and equal. As best shown in FIG. 13, the grooves or slots 130 have side walls 132 and bottom walls 134. The grooves or slots 130 are similar to the grooves or slots 30. Therefore, the description provided above will not be repeated.

The illustrative components described above with respect to platform 20 may be used with platform 120. As the function and operation of the components which cooperate with the top surface 122 of the platform 120 are the same as the components which cooperate with the top surface 22 of the platform 20 will not be repeated.

Grooves or slots 140 are provided in the platform 120 and extend from the lower surface 124 toward the upper surface 122. In the embodiment shown, the grooves or slots 140 extend from one end wall 128 to the other end wall 128 in a direction parallel to a longitudinal axis of the platform 120.

In the illustrative embodiment shown, two grooves or slots 140 extend across the width of the platform 120. However, other numbers of grooves or slots 140 may be used without departing from the scope of the invention. As best shown in FIG. 13, the grooves or slots 130 have side walls 142, top walls 144 and shoulders 146.

Referring to FIG. 14, a first illustrative lower component 150 which cooperates with the slots 140 is shown. The particular lower component 150 shown is configured to hold paper. The lower component 150 can also be used to hold other items such as notes, folders, etc.

The lower component 150 has side walls 152 which extend from a bottom surface 154 of the lower component 150. Attachment members 156 extend from the side walls 152. In the embodiment shown, the attachment members 156 extend from one side wall 152 toward the other side wall 152. The attachment members 156 are also positioned essentially parallel to the bottom surface 154. The attachment members have latching notches 158 provided at ends thereof.

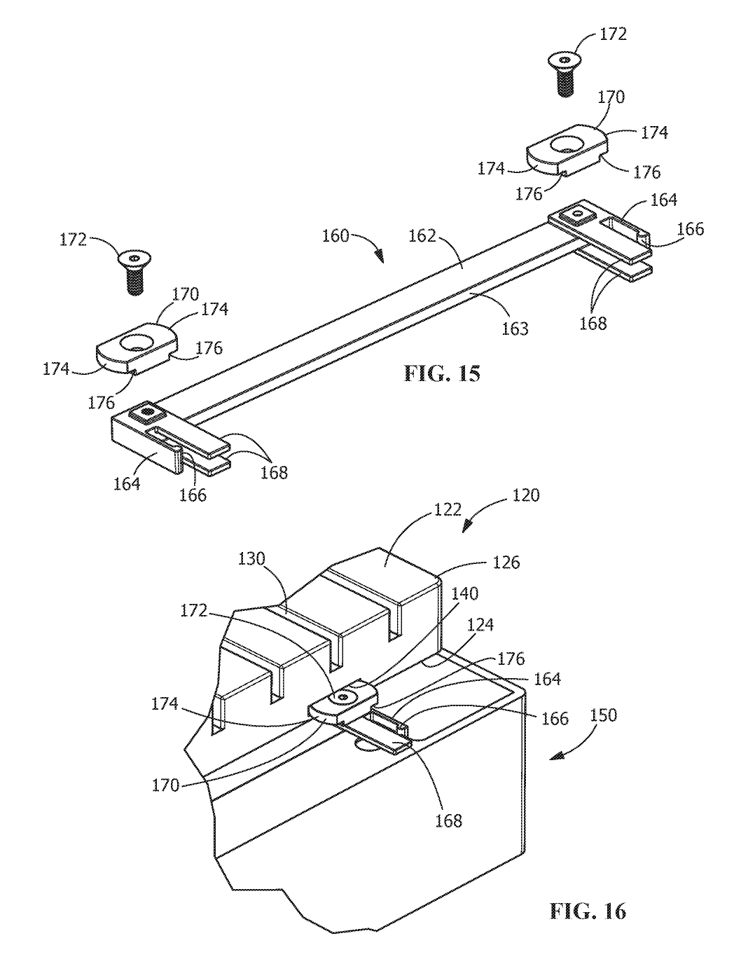

Referring to FIG. 15 a hanging clip 160 is shown. The hanging clip 160 has a base member 162 with a side surface 163 provided therein. The slot 164 is dimensioned to fit over a portion of the attachment members 156. Positioned at either end of the base member 162 are latching arms 164 with latching projections 166. Stabilization arms 168 are provided proximate the latching arms 164. Groove engagement members 170 are provided proximate the ends of the base member 162. The groove engagement members 170 are secured to the base member 162 by mounting hardware 172. The groove engagement members 170 have side walls 174 and shoulders 176. The side walls 174 of each groove engagement member 170 are spaced apart a distance which is approximately equal to, but slight smaller than the spacing between the side walls 142 of the slots 140. The shoulders 176 are configured to engage the shoulders 146 of the slots 140.

In operation, the hanging clips 160 are mounted on the attachment members 156 of the component 150. In this position, the side surfaces 163 of the hanging clips 160 engage the attachment members 156. The stabilization arms 168 are positioned on top of and below the attachment members 156 to provide proper support to the component 150. The hanging clips 160 are maintained in position on the attachment members 156 by the cooperation and engagement of the latching projections 166 of the latching arms 164 with latching notches 158 of the attachment members 156.

With the hanging clips 160 properly secured to the component 150, the groove engagement members 170 are inserted into the slots 140 of the platform 120 are moved or slide to the proper position. The cooperation of the shoulders 176 of the groove engagement members 170 and the shoulders 146 of the slots 140 retain the components 150 is position relative to the platform 120

As best shown in FIGS. 11 and 12, legs 180 may also be inserted the slots 140 and retained therein. The legs 180 could be positioned in the slots 140 in a manner to allow the legs 180 to provide the stable support required while allowing the legs 180 to be removed when required. The legs 180 may also be adjustable to allow the platform 120 to be level when positioned on a desk or table top. However, other embodiments and other methods of attaching the legs may be used.

While the embodiment shown in FIGS. 11 and 12 has a platform 120 with two components 150 provided on the bottom surface 124 thereof, other configurations may be provided without departing from the invention. For example, but not limited to, the platform may have a length which is essentially equal to the length of the component, allowing the platform to be used on top of an inbox.

The invention, as illustrated in the illustrative embodiments shown, relates to a method, system and apparatus to organize and personalize a desk or table top workspace to achieve a universal mode for efficiency through modular component arrangements. The invention may be used in all business, office or home environments. The organizer is a hub for customization and increased productivity, which is configured to hold all of the essentials and eliminate clutter. Each of the components is designed on a grid and can be rotated or moved along the base or platform. The organizer consolidates everything into one organized space.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A desk or table top organizer comprising:
a platform having an upper surface and an oppositely facing lower surface, the upper surface having a plurality of grooves extending in a direction parallel to a longitudinal axis of the platform, spacing between the grooves is consistent and equal, with the spacing between adjacent grooves equal to a distance A;
an upper component positioned on the platform, the upper component having a plurality of legs extending from a bottom surface of the upper component, a first pair of legs of the plurality of legs spaced apart by a distance B, a second pair of legs of the plurality of legs spaced apart by a distance C;
wherein the distance B being a multiple of the distance A and the distance C being a multiple of the distance A, allowing the upper component to be positioned in various positions and orientations on the platform.

2. The desk or table top organizer as recited in claim 1, wherein the grooves extend across the width of the platform

3. The desk or table top organizer as recited in claim 1, wherein the grooves extend from proximate an end wall of the platform to proximate an opposed end wall of the platform.

4. The desk or table top organizer as recited in claim 1, wherein the grooves have side walls and bottom walls, the side walls are essentially parallel to each other and essentially perpendicular to the bottom or end wall.

5. The desk or table top organizer as recited in claim 1, wherein the legs of the upper component extend from each respective corner of the bottom surface.

6. The desk or table top organizer as recited in claim 1, wherein legs are separate pieces which are attached to the bottom surface.

7. The desk or table top organizer as recited in claim 1, wherein the distance B and the distance C are equal, whereby the upper component can be rotated to fit on the platform is different orientations.

8. The desk or table top organizer as recited in claim 1, wherein one or more platform magnets are positioned on one or more walls of the platform.

9. The desk or table top organizer as recited in claim 8, wherein an extension component has one or more component magnets positioned on one or more walls of the extension component, the one or more component magnets are configured to magnetically cooperate with the one or more platform magnets of the platform and have sufficient strength to releasably maintain the extension component in place relative to the platform, thereby preventing the unwanted movement of the extension component relative to the platform.

10. The desk or table top organizer as recited in claim 1, wherein slots are provided in the lower surface of the platform, the slots extend from proximate an end wall of the platform to an opposed end wall of the platform, the slots have slot side walls, slot top walls and slot shoulders.

11. The desk or table top organizer as recited in claim 10, wherein a lower component cooperates with the slots are provided in the lower surface of the platform, the lower component has hanging clips which are configured to be received in the slots in the lower surface of the platform,

12. A desk or table top organizer comprising:
a platform having an upper surface and an oppositely facing lower surface, the upper surface having a plurality of grooves extending in a direction parallel to a longitudinal axis of the platform, the lower surface having a plurality of slots extending in a direction parallel to a longitudinal axis of the platform;
an upper component positioned on the platform, the upper component having a plurality of legs extending from a bottom surface of the upper component, the plurality of legs positioned in the grooves of the upper surface to maintain the upper component on the platform;
a lower component positioned on the platform, the lower component having a plurality of hanging clips positioned in the slots of the lower surface to maintain the lower component on the platform.

13. The desk or table top organizer as recited in claim 12, wherein legs positioned in the slots of the lower surface of the platform.

14. The desk or table top organizer as recited in claim 13, wherein the grooves extend across the width of the platform.

15. The desk or table top organizer as recited in claim 14, wherein the grooves extend from proximate an end wall of the platform to proximate an opposed end wall of the platform.

16. The desk or table top organizer as recited in claim 15, wherein the slots extend from the end wall of the platform to the opposed end wall of the platform.

17. A desk or table top organizer comprising:
a platform having an upper surface and an oppositely facing lower surface, the upper surface has a plurality of grooves extending in a direction parallel to a longitudinal axis of the platform, the lower surface having a plurality of slots extending in a direction parallel to a longitudinal axis of the platform;
an upper component positioned on the platform, the upper component having a plurality of legs extending from a bottom surface of the upper component, the plurality of legs positioned in the grooves of the upper surface to maintain the upper component on the platform;
one or more platform magnets positioned on one or more walls of the platform;
an extension component having one or more component magnets positioned on one or more walls of the extension component, the one or more component magnets configured to magnetically cooperate with the one or more platform magnets of the platform and have sufficient strength to releasably maintain the extension component in place relative to the platform, thereby preventing the unwanted movement of the extension component relative to the platform.

18. The desk or table top organizer as recited in claim 17, wherein the one or more platform magnets are inset into the one or more walls of the platform.

19. The desk or table top organizer as recited in claim 17, wherein the one or more component magnets are inset into the one or more walls of the extension component.

20. The desk or table top organizer as recited in claim 17, wherein the lower surface of the platform has a plurality of slots extending in a direction parallel to a longitudinal axis of the platform, a lower component is positioned on the lower surface of the platform, the lower component having a plurality of hanging clips positioned in the slots of the lower surface to maintain the lower component on the platform.
